(19) United States
(12) Patent Application Publication
(10) Pub. No.: US 2006/0262729 A1
(43) Pub. Date: Nov. 23, 2006

(54) Method and system for testing communication protocols in network communication

(76) Inventors: Man Chun Steven Chau, Hong Kong (CN); King Chung Yu, Hong Kong (CN)

Correspondence Address: KNOBBE MARTENS OLSON & BEAR LLP, 2040 MAIN STREET, FOURTEENTH FLOOR, IRVINE, CA, 92614, US

(21) Appl. No.: 11/131,748

(22) Filed: May 17, 2005

(51) Int. Cl. H04J 1/16

(52) U.S. Cl. 370/250

(57) ABSTRACT

A framework or system is described for testing compliance and robustness of a communication signal protocol employed by an entity which is connected to an IP based network, particularly for testing a SIP enabled entity or device. Within the framework, multiple test clients are coordinated by a centralized test controller and thus test progress and results can be controlled and monitored in a centralized manner. The framework uses simple template-based test scripts which are easy to write and does not involve complex programming constructs.

### FIELD OF THE INVENTION

This invention relates to a method and a system for testing communicating protocols used in networks, such as the Internet. More particularly, it relates to a testing method and system for testing compliance and robustness of a device employing a particular signaling protocol in communication with other devices using the same signaling protocol, such as, in particular, the Session Initiation Protocol (SIP).

### BACKGROUND OF THE INVENTION

Network communications, such as those running through the Internet, need a signaling protocol to establish presence, locate users, and initiate, modify or terminate sessions. One of the popular signaling protocols nowadays is the Session Initiation Protocol (SIP). It is a protocol for network conferencing, telephony, presence, events notification and instant messaging. SIP was developed within the IETF MMUSIC (Multiparty Multimedia Session Control) working group and has since rapidly become a fundamental building block of various forms of multimedia communication over IP based networks. Because of this, an SIP enabled entity (a device using SIP as signaling protocol) must meet new challenges and threats posed by an all-IP environment, and its compliance and robustness must be ensured by timely testing.

To ensure that the SIP implementation in an SIP entity complies with the standard and is free of flaws which may lead to system security compromise and/or unexpected system crashes, a thorough testing should be conducted prior to deployment. There are a number of test tools now commercially available. Examples of such testers can be found on the websites:

www.testingtech.de/products/ttsuite_sip.php;

www.solinet.com/sip_conf_tester.htm; and

www.codenomicon.com/testtools/sip/index.html.

The available testing methods require the skill and effort of writing complex scripts or programs and are limited to testing communication between two SIP entities.

Therefore, the need exists for a simpler and more economical way to conduct thorough testing on network communications which may involve more than two entities.

### SUMMARY OF THE INVENTION

Embodiments of the present invention provide a new method and system for testing an entity of a particular network using a particular signaling protocol, such as SIP, which are configured for testing complex network communications based on the protocol and involving a number of entities connected to the network. Embodiments of the present invention also provide a testing framework for using template-based testing scripts which are simpler to write without using complex programming constructs and for providing flexible, extendable, scalable, customizable and easy-to-use testing methods.

Embodiments of the present invention are attained by providing a testing framework which (i) uses simple scripts, preferably, template-based text file scripts, (ii) has one centralized test controller referred to as “TestDirector” and (iii) has one or more test clients referred to as “Negotiators.” The TestDirector and Negotiator(s) are all software implementations which can all run in a single computer or several computers. The TestDirector has connectivity to all Negotiators so that it can issue commands to them. All Negotiators and the System Under Test (hereinafter “SUT”) are connected to the same network where they communicate over a protocol such as TCP or UDP. For the testing framework of this invention, the SUT can be any entity that uses the signaling protocol under test. For example, for a SIP testing framework, the SUT can be any SIP enabled entity, such as a SIP proxy, SIP redirect server, SIP phone, SIP TV, etc. The method and system of the present invention can be readily adapted to testing other network protocols by people skilled in the art based on the following detailed description about their use in testing IP based networks.

The various features of novelty which characterize the invention are pointed out with particularity in the claims annexed to and forming a part of this disclosure. For a better understanding of the invention, its operating advantages, and specific objects attained by its use, reference should be made to the drawings and the following description in which there are illustrated and described embodiments of the invention.

### BRIEF DESCRIPTION OF THE DRAWINGS

FIG. 1 is a diagram showing a static view of the infrastructure of the testing framework of embodiments of the present invention.

FIG. 2 is a diagram showing the testing framework of FIG. 1 in action.

FIG. 3 is a flow chart showing high-level work flow of the testing framework of embodiments of the present invention.

FIG. 4 is a flow chart showing details within block A5 of the flow chart in FIG. 3.

FIG. 5 is a flow chart showing details within block A5-4 of the flow chart in FIG. 4.

FIG. 6 depicts an example of hierarchy of test cases.

### DETAILED DESCRIPTION OF CERTAIN EMBODIMENTS

The infrastructure of the Testing Framework of Embodiments of the Present Invention

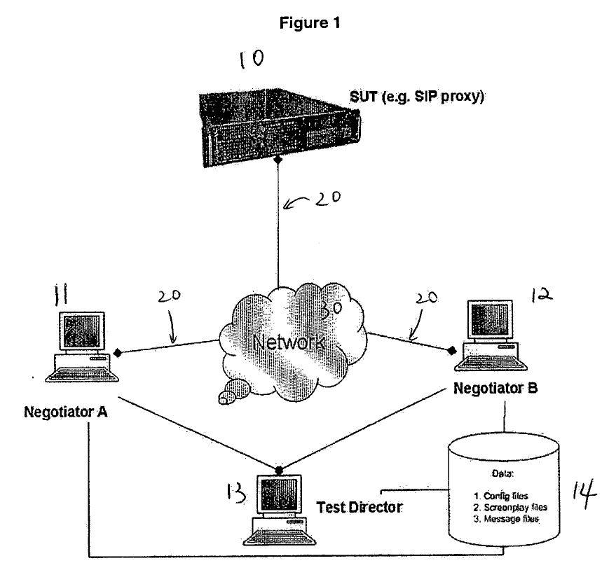

Referring now to FIG. 1, it is a typical infrastructure of the testing framework for testing SIP entities. The infrastructure comprises an SUT 10 (system under test), two Negotiators 11 and 12, which are running in two separate computers. SUT 10, and Negotiators 11 and 12 are connected to the same network 30, with connection 20 which is either TCP or UDP based in certain embodiments. In addition, Negotiators 11 and 12 are connected to TestDirector 13 through any predefined controlling protocol which can be readily designed and implemented by people with ordinary skill in the art, whereby receiving commands from TestDirector 13. Negotiators and TestDirector are all software implementations and can be written by people skilled in the computer programming using any suitable computer programming languages, such as BASIC, Pascal/Delphi, C/C++, JAVA, C#, to name just a few. Although Negotiators and TestDirector are shown in FIG. 1 as running in separate computers, they can be implemented to run in a single computer where each Negotiator and the TestDirector has its own assigned network port number. Regardless of whether Negotiators and TestDirector are running in the same or separate computers, they can all retrieve files stored in the same source 14. The typical files include, but not limited to, (1) configuration files for Negotiators and TestDirector, (2) Screenplay files for defining the test cases; and (3) Message files for supporting the screenplay files. The SUT is the subject of the test and for this particular SIP testing framework it can be any SIP entities. Of course, the framework can be readily adopted by people of ordinary skill for testing other signaling protocols.

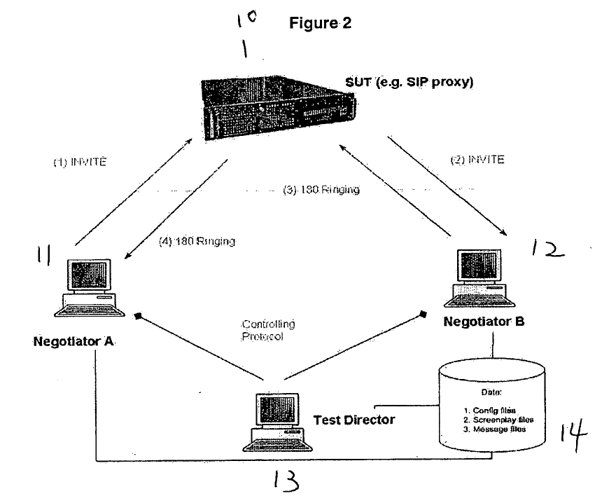

FIG. 2 depicts what happens when TestDirector is executing a typical test case. The TestDirector detects when the Negotiators begin executing a test case. In certain embodiments, before a test case starts, three types of files must be prepared and ready for retrieval by the TestDirector and Negotiators: Configuration file, Screenplay file and Message file. Those files are detailed in the following.

Configuration files include the profiles of the TestDirector and all Negotiators. The profile of the TestDirector contains the network address (IP address and the port number) at which it can be contacted. The profile of a Negotiator includes the network address which it listens on for incoming SIP traffic and other user-defined properties. The number of properties that the user can define is unlimited.

The screenplay file of a test case contains instructions about what the Negotiators should do and in what order they execute the test case. The syntax and format of the file will be discussed in a later section.

Message files are text files that contain the template of SIP messages that Negotiators will use for sending SIP messages and comparing SIP messages that they actually received.

When the Negotiators execute a test case, they are actually carrying out the instructions set forth in the screenplay file for the test case. In a particular implementation, there are two types of instructions, namely SEND and RECEIVE. In other words, the Negotiators will either be sending out messages to the SUT or other entities in the network, or expecting to receive messages from the SUT or other entities. If the situation allows a Negotiator to carry out its instructions to its completion, it will send a PASS signal to the TestDirector, telling him that it has completed its own responsibilities successfully. On the other hand, if the situation does not allow a Negotiator to carry on with its execution (for example, when an expected message does not arrive in time), it will send a FAILURE signal to the TestDirector, telling him what actually went wrong. Of course, when needed, more types of instructions may be implemented by people skilled in the art.

As the test case is being executed, the TestDirector consolidates the reports collected from the Negotiators. As soon as it arrives at a conclusion, it tells all Negotiators to stop and displays the result of the test case on screen.

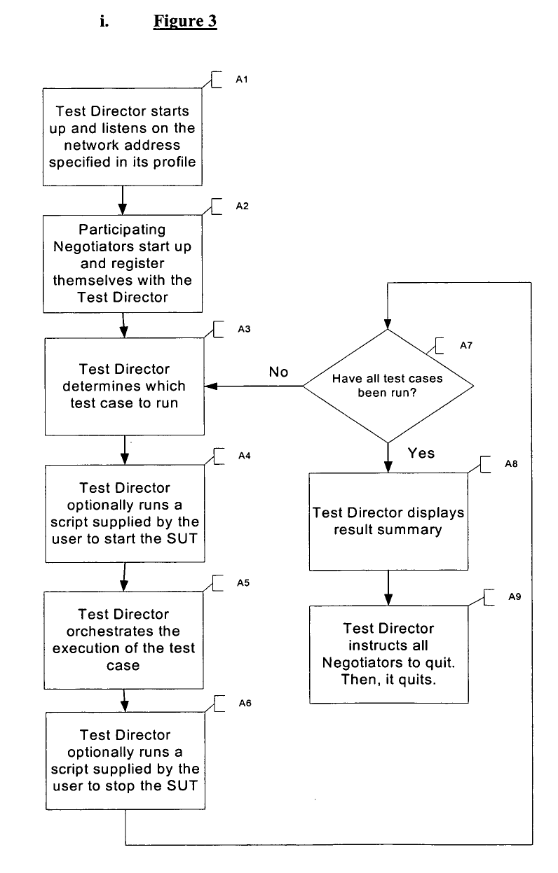

FIG. 3 shows a high-level work flow of the testing framework of the present invention. Detailed descriptions about each block in the flow chart are as follows:

A1: The software program TestDirector is started up by a user (which can be a human being or another software program) on a computer. The user also specifies to the TestDirector the set of test cases to be executed. The TestDirector reads its profile from the common data source and determines from the profile what network address (typically, a network address is composed of an IP address and a port number) it will listen on for Negotiators to contact it for registration later on. It then listens on that network address.

A2: One or more instances of the software program Negotiator are started up by a user (which can be a human being or another software program) on the same computer or other computers. The user also indicates to the Negotiators what role it is going to play. For example, one instance of the Negotiator is going to play Negotiator A; while another instance of the Negotiator is going to play Negotiator B. Each Negotiator reads the profile of its own, the profile of other Negotiators and the profile of the TestDirector from the common data source and determines what characteristics it will take on and the network address to contact the TestDirector. Then, each Negotiator will contact the TestDirector to register itself with it. Once the TestDirector accepts their registration, a predefined communication channel is set up between the TestDirector and each Negotiator. The communication channel, which for example can be implemented using Java's RMI (Remote Invocation Method) technology, is used for the TestDirector to issue commands to the Negotiators and for the Negotiators to submit their test report or feedback to the TestDirector during the execution of test cases. The communication channel, of course, may be implemented by other methods and its implementation is within ordinary skill of a person skilled in the art.

A3: From the set of test cases indicated by the user, the TestDirector determines which test case to run next. For example, if the user specified that test cases T01, T02, and T03 are to be executed, the TestDirector will determine which test case to run first, second and third. For a particular implementation, it may make the decision based upon alphabetical order.

A4: The TestDirector runs a script (e.g., shell script, bat script, perl script or other executable files) provided by the user if the user so desires. The script is stored in the common data source. Typically, the script is used to start and stop the SUT (System Under Test) in order to make sure the SUT has a clean state at the beginning of each test case. But, technically speaking, the script can perform any tasks the user wants to do. If the user has chosen not to run the script, this step will be skipped. The following is an example of such script:

“subject_ctl.sh start T01”

where subject_ctl.sh is the name of the script, and start and T01 are the arguments passed to the script. T01 is the name of the test case which is going to be executed.

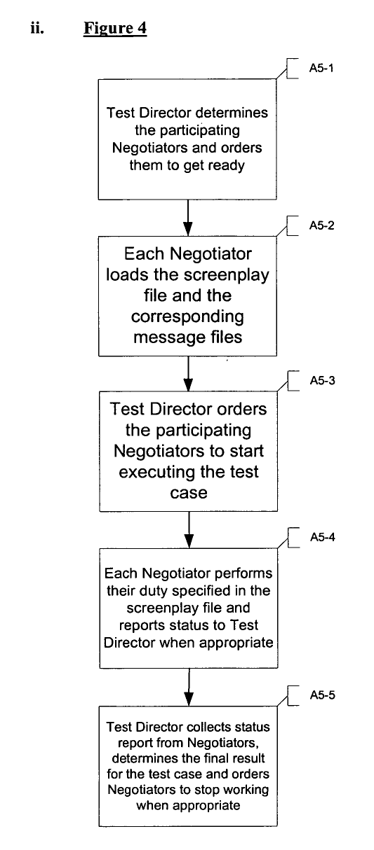

A5: The TestDirector coordinates with the Negotiators to execute the test case. For details of this step, see the description corresponding with FIG. 4.

A6: The TestDirector runs a script (e.g., shell script, bat script, perl script or other executable files) provided by the user if the user so desires. This is an optional step similar to A4. For example, the following script can be run to stop SUT

“subject_ctl.sh stop T01”

where subject_ctl.sh is the name of the script, and stop and T01 are the arguments passed to the script. T01 is the name of the test case that has just been executed.

A7: The TestDirector determines whether or not all the test cases specified by the user have already been executed. If there are still test cases left to be executed, it will go back to A3. If all the test cases have already been executed, it will then proceed to A8.

A8: The TestDirector calculates the summary of the test results and displays it to the user. For a particular implementation, the summary includes the total number of test cases executed, the number of test cases passed and the number of test cases failed. It is contemplated that the summary may include other information when needed.

The word “display” refers to a mechanism by which a program conveys some information to the user. It can be achieved, for example, by outputting the information on a computer screen, by printing it on papers, or by playing out a message through the speakers.

A9: The TestDirector issues a “DISMISS” command to all participating Negotiators via the communication channel set up in A2 to order them all to quit gracefully. The Negotiators obey the command and quits gracefully. Then, the TestDirector quits itself gracefully too.

FIG. 4 details what happens in block A5 in the flow chart of FIG. 3. Each block in FIG. 4 is further described as follows:

A5-1: The TestDirector determines from the screenplay file what Negotiators will participate in the test case it is going to execute. It then issues a “GET READY” command along with a unique identifier (ID) of the test case (e.g., the name of the test case) to each participating Negotiator via the communication channel set up in A2 to order them to get ready for the execution of the test case.

A5-2: Upon reception of the “GET READY” command, each participating Negotiator loads the screenplay file for the test case and the corresponding message files referenced in the screenplay file into the memory for use during the actual execution.

A5-3: When all participating Negotiators are ready, the TestDirector issues an “ACTION” command to each of them via the communication channel set up in A2 to order them to start executing the test case.

A5-4: Upon reception of the “ACTION” command, each Negotiator performs their duty by carrying out the instructions in the screenplay file that are related to them and ignoring the others.

If a Negotiator can execute all the relevant instructions in the screenplay file without errors, it will submit a “PASS” report to the TestDirector via the communication channel set up in A2, telling the TestDirector that things happened as expected from its perspective.

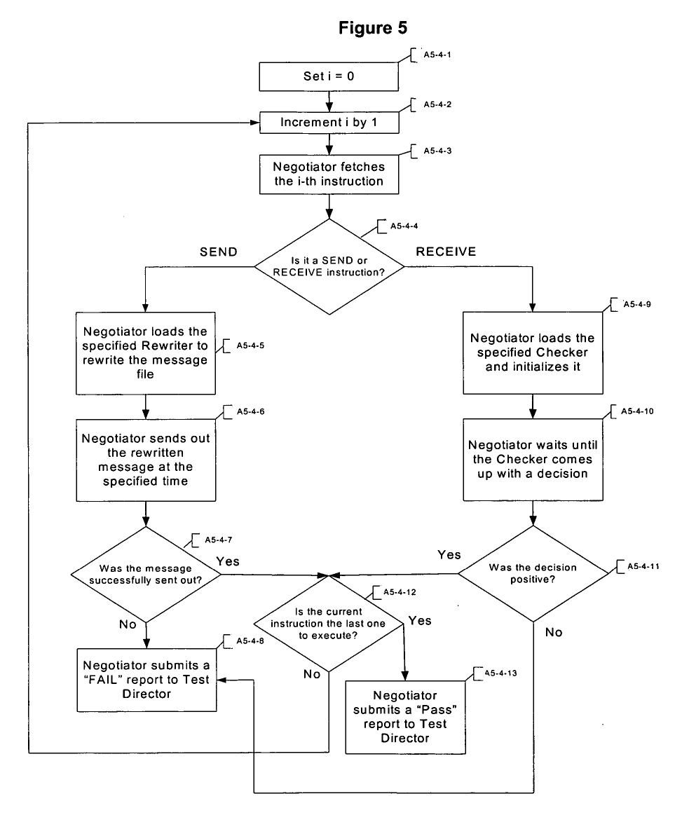

However, when a Negotiator encounters something that is beyond expectation (e.g., an expected message never arrived), it will submit a “FAIL” report to the TestDirector via the communication channel set up in A2, telling the TestDirector what went wrong. For more details on what happens in this block, see the description corresponding with FIG. 5.

A5-5: The TestDirector waits to collect status reports (“PASS” or “FAIL”) from the participating Negotiators. It consolidates the reports and derives the final result for the test case in the following manner (the next two paragraphs):

As soon as a “FAIL” report is received from any Negotiator, the TestDirector arrives at the conclusion that the entire test case is a failure.

The entire test case will only be treated as a success when all participating Negotiators have submitted a “PASS” report to the TestDirector.

As soon as a final result has been derived, the TestDirector will issue a “CUT” command to all participating Negotiators to order them to stop working. The Negotiators will then stop executing the instructions given in the screenplay file, release unneeded memory, close all unneeded connections, and ignore further incoming packets until the next test case begins.

FIG. 5 describes in more detail what happens in block A5-4 FIG. 4. This flow chart describes what actions each Negotiator will take in what sequence. For the sake of better readability, the following text uses “Negotiator” in place of “Each Negotiator”.

A5-4-1: Negotiator initializes its own variable i to zero.

A5-4-2: Negotiator increments the variable i by 1.

A5-4-3: Negotiator fetches the first relevant instruction from the screenplay file. A relevant instruction is one that the Negotiator has to execute. All irrelevant instructions will be ignored by the Negotiator. For example, Negotiator B will ignore all instructions that are meant to be executed by Negotiator A, and will only execute those instructions that are meant to be executed by Negotiator B. In a particular embodiment, Field 1 of the instruction specifies the name of the Negotiator that should execute the instruction. Of course this indication may be implemented in other suitable way to obtain a satisfactory result.

A5-4-4: Negotiator will behave differently according to the action type of the instruction. For this particular implementation, there are two action types, namely SEND and RECEIVE.

A5-4-5: An instruction of type SEND specifies which Rewriter the Negotiator should use to rewrite the message file for the current instruction. At this step, Negotiator loads the designated Rewriter to produce the message to be sent based upon the content of the message file.

Typically, a Rewriter resolves predefined tags in the message file with actual values. Thus, Rewriters can be customized to rewrite the message file in any fashion by the user. For more information about how Rewriters work, see the Section “SIP-Director: Rewriters and Checkers”.

A5-4-6: The instruction also specifies a delay duration before Negotiator sends out the rewritten message. At this step, Negotiator waits for the delay duration to pass and then sends out the rewritten message to the specified target. The specified target is usually the SUT but it can be any network address.

A5-4-7: Negotiator detects to see if the sending of the message resulted in any errors.

A5-4-8: Negotiator submits a “FAIL” report to the TestDirector via the communication channel set up in A2, telling the TestDirector the reason for the failure.

A5-4-9: An instruction of type RECEIVE specifies which Checker the Negotiator should use to determine whether or not the message(s) received by the Negotiator is/are correct. At this step, Negotiator loads the specified Checker and initializes it with the content of message file referenced in the current instruction and the value of the timeout duration specified in the current instruction in the screenplay file.

A5-4-10: Negotiator waits until the Checker comes up with a decision on whether or not the message(s) received by the Negotiator is/are correct. For a given scenario, different Checkers make different decisions. Typically, Checkers make their decision based upon the content of the received messages and the timing of the arrival of the messages. Furthermore, Checkers can be readily customized to make decisions in a completely different fashion by the user. For more information about how Checkers work, see the Section “SIP-Director: Rewriters and Checkers”.

A5-4-11: Negotiator will behave differently based upon the decision given by the Checker. Decision is either positive or negative. A positive decision will lead the Negotiator to block A5-4-12, while a negative one will take it to block A5-4-8.

A5-4-12: Negotiator checks to see if the current instruction is the last relevant instruction in the screenplay file.

A5-4-13: Negotiator submits a “PASS” report to the TestDirector via the communication channel set up in A2, telling the TestDirector that things happened as expected from its perspective.

Syntax and Semantics of the Files of A Particular Embodiment

(A) Profile of TestDirector

Syntax:

TestDirector:<IP address>:<port>

Explanation and Semantics:

(a) This file contains only one line.

(b) The line consists of three fields separated by colon.

(c) The first field must read “TestDirector”.

(d) The second field specifies the IP address of the machine on which the TestDirector will run.

(e) The third field specifies the port number on which the TestDirector will listen for registration of Negotiators prior to the execution of test cases.

(B) Profile of a Negotiator

Syntax:

role.location = 10.5.2.198:5000
<property entry>
<property entry>
<property entry>
...
, where
<property entry> is
<property name> = <property value>

Explanation and Semantics:

(a) This file defines the characteristics of the Negotiator under concern.

(b) This file consists of any number of property entries. The user can define any properties as they like. There is only one mandatory property that the user must define.

(c) A property entry is composed of two fields separated by the equal sign and ends with a carriage return. The first field is called the property name and the second field is called the property value.

(d) The property name is composed of one or more alphanumeric characters.

(e) The property value is composed of one or more non-carriage-return characters.

(f) The name of the mandatory property is “role.location” and its value is an IP address and port number separated by a colon.

(g) The Negotiator uses the mandatory property to determine the network address (i.e., IP address and port number) on which it will listen for incoming messages from the SUT and other entities.

(C) Screenplay File

Syntax:

<instruction>
<instruction>
<instruction>
...
, where
<instruction> is
<field 1>:<field 2>:<field 3>:<field 4>:<field 5>:[<field 6>]

Explanation and Semantics:

(a) This file contains the instructions that are going to be executed by the Negotiators.

(b) In short, an instruction defines who should send what message at what time or who should expect to receive what message by what time.

(c) This file is composed on one or more instructions.

(d) An instruction is a line consisting of 5 or 6 fields. The fields are separated by colon. The line is terminated by CRLF or CR.

(e) Field 1 specifies the name of the Negotiator which will execute this instruction.

(f) Field 2 specifies the action the Negotiator will take. Possible values are either SEND or RECEIVE.

(g) “SEND” instructs the Negotiator to send a message.

(h) “RECEIVE” instructs the Negotiator to expect an incoming message.

(i) Field 3 specifies the name of a Rewriter or Checker that the Negotiator will use. See the section “SIP-Director: Rewriters and Checkers” for details.

(j) If the action type of the instruction is “SEND”, the name of a Rewriter should be specified.

(k) If the action type of the instruction is “RECEIVE”, the name of a Checker should be specified.

(l) Field 4 is the file name of the message file that the Rewriter or Checker will use.

(m) Field 5 specifies the duration in milliseconds.

(n) If the action type of the instruction is “SEND”, the duration will be interpreted as a delay duration by the Negotiator.

(o) If the action type of the instruction is “RECEIVE”, the duration will be interpreted as a timeout value by the Checker.

(p) Field 6 is required only when the action type of the instruction is “SEND”. It specifies the name of a property whose value is a network address which the Negotiator will send the message to. In short, it specifies the destination.

(D) Message File

The Message file is a text file and no syntax is required.

Explanation and Semantics:

(a) This file contains a message template or a criteria template which a Rewriter or Checker will process for the sending or checking of messages.

(b) This file is to be interpreted by a Rewriter or Checker. Therefore, the text a user may want to put in this file depends on what Rewriter or Checker is being used and what effect the user wants to achieve.

(c) Typically, this file contains a SIP-message-like content with proprietary tags and markers for use by our proprietary Rewriter or Checker.

(d) See the section “SIP-Director: Rewriters and Checkers” for more information about how the message file is used by Rewriters and Checkers.

SIP-Director: Rewriters and Checkers

Rewriters and Checkers are software modules that assist the Negotiator to carry out the instructions in the screenplay file. They play a role in practicing embodiments of the present invention and form at least a portion of this testing framework.

A Rewriter is a software module that conforms to a standard interface (Application Programming Interface or API) and is responsible for transforming a given message file into another form. SIP-Director allows the user of the testing tool to supply their own Rewriters, thereby giving the user the freedom to design and transform message files in any imaginable way. For the purpose of illustration, a set of sample Rewriters for convenience will be discussed later in this section.

Similarly, a Checker is a software module that conforms to a standard interface (Application Programming Interface or API) and is responsible for determining the correctness of one or more messages received by the Negotiator with a timeout constraint. SIP-Director allows the user of the testing tool to supply their own Checkers, thereby giving the user the freedom to define their own way of determining the correctness of received messages. For the purpose of illustration, a set of sample Checkers will be provided and discussed later in this section.

In view of the foregoing disclosure, it is obvious that application of the testing framework of embodiments of the present invention are not limited to the SIP protocol. People with ordinary skill in the art can, following the teachings of the above embodiment of SIP testing framework, readily adopt it for testing any other communication protocol.

Rewriter:

As mentioned earlier, a Negotiator relies on Rewriters to rewrite the message file before it sends out the rewritten message. Therefore, a Rewriter will be used by a Negotiator when the Negotiator is executing an instruction whose action type is “SEND”.

The users of the SIP-test framework can choose to design and use their own Rewriters. For the purpose of illustration, two sample Rewriters will be provided and discussed in the following: (a) NoopRewriter; (b) StandardRewriter.

NoopRewriter does not perform any operations on the message file. In other words, it leaves the message file unchanged. As a result, any content the user puts in the message file will be sent out by the Negotiator AS IS after the delay duration has passed.

StandardRewriter rewrites the message file by replacing predefined tags with actual values. A tag is a segment of text that conforms to a pre-defined pattern. All tags recognized by the StandardRewriter have the following pattern:

[X˜Desc],

where the square brackets mark the boundary of the tag, the X is the category of the tag (there are 4 categories, namely P, H, C, and D), the tilde is the separator, and Desc tells the StandardRewriter how it should replace the tag.

The 4 categories of tags that the StandardRewriter will rewrite are

(a) Property tags,

(b) Constant tags,

(c) Dynamic tags, and

(d) History tags

Property Tags:

In short, Property tags are to be resolved to property values by StandardRewriter. Property tags take the following form:

[P˜property_name(˜negotiator_name)]

Explanation:

(a) P stands for Property tag.

(b) property_name is the name of the property whose value this tag will be resolved to.

(c) negotiator_name is the name of the Negotiator whose profile will be used to look up the value of the property. This field is optional. When omitted, StandardRewriter will use the profile of the Negotiator who is executing the current instruction in the screenplay file to rewrite the message file to look up the value of the property.

Examples:

(a) [P˜subject.location]

The above property tag tells StandardRewriter to replace the tag with the value of the property “subject.location” found in the profile of the Negotiator who is executing the current instruction.

(b) [P˜role.uri.domain˜B]

The above property tag tells StandardRewriter to replace the tag with the value of the property “role.uri.domain” found in the profile of Negotiator B.

Constant Tags:

In short, Constant tags are to be resolved to a common constant value among all participating Negotiators. A new constant value is given to all Negotiators before the execution of each test case. Constant tags take the following form:

[C·predefined_token(˜suffix)]

(a) C stands for Constant tag.

(b) predefined_token is the name of the constant that this tag will be resolved to the following possible values:
(1) Call-ID: resolved to a text string that may contain letters, punctuation points and digits
(2) BranchCookie: resolved to a text string that begins with the magic cookie as specified in RFC 3261 (RFC stands for Request for Comments. For details, see: http://www.fags.org/rfcs/rfc3261.html), which is hereby incorporated by reference.
(3) Alphanumeric: resolved to a text string that contains alphanumeric characters
(4) Numeric: resolved to a text string that only contains digits

(c) suffix is a piece of text that will be appended to the end of the resolved value. This field is optional. When omitted, no extra text will be appended.

Examples:

(a) [C˜Call-ID]

The above constant tag tells StandardRewriter to replace the tag with a text string that may contain letters, punctuation points and digits.

(b) [C˜BranchCookie]

The above constant tag tells StandardRewriter to replace the tag with a text string that begins with the magic cookie as specified in RFC 3261.

(c) [C˜BranchCookie˜abc]

The above constant tag will be resolved to the same value as the previous one with the extra text “abc” appended to the end.

Dynamic Tags:

The dynamic tag is to be resolved to a value that depends on the content of the message file. Dynamic tags take the following form:

[D˜predefined_token]

(a) D stands for Dynamic tag.

(b) predefined_token tells the StandardRewriter how it should calculate the value. For this example, there is only one possible value (more tokens may be defined as needed): content-length. It is resolved to a number reflecting the number of bytes of the SIP message body found in the message file.

Examples:

[D˜Content-length]

The above constant tag tells StandardRewriter to replace the tag with a number reflecting the number of bytes of the SIP message body found in the message file.

History Tags:

History tags are to be resolved to SIP headers which are extracted from SIP messages sent out by the Negotiator or received by the Negotiator previously. History tags take the following form:

[H˜header_name˜scope˜index]

Explanation:

(a) H stands for History tag.

(b) header_name specifies the name of the SIP header which is to be extracted. For a complete list of SIP header names, refer to RFC 3261.

(c) scope tells how many lines of SIP header to be extracted. Possible values are
(1) First: When multiple lines of the desired SIP header are present, only the first line is extracted.
(2) All: All lines of the desired SIP header will be extracted.

(d) index tells the StandardRewriter which previously-sent or previously-received message should be used for the extraction of SIP header. The word “History” refers to all SIP messages that were sent out by the Negotiator or received by the Negotiator before the current instruction is executed. This field selects which message the StandardRewriter should use. Possible values are:
(1) r-<n>: r stands for received SIP messages; n is a history index. For example, “r-1” refers to the last SIP message received by the Negotiator; “r-2” refers to the second last SIP message received by the Negotiator.
(2) s-<n>: s stands for sent SIP messages; n is a history index. For example, “s-1” refers to the last SIP message sent out by the Negotiator; “s-2” refers to the second last SIP message sent out by the Negotiator.

Examples:

(a) [H˜Contact˜First˜r-1]

The above history tag tells StandardRewriter to replace the tag with the first line of “Contact” header found in the last SIP message received by the Negotiator.

(b) [H˜Record-Route˜All˜r-2]

The above history tag tells StandardRewriter to replace the tag with all lines of “Record-Route” header found in the second last SIP message received by the Negotiator.

(c) [H˜Via˜First˜s-2]

The above history tag tells StandardRewriter to replace the tag with the first line of “Via” header found in the second last SIP message sent out by the Negotiator.

The Property tags, Constant tags and Dynamic tags allow SIP-Director to construct text messages (not necessarily SIP messages) based on run-time parameters. Therefore, the construction of messages is dynamic in nature.

The History tags enable the user of the testing tool to construct message templates whose content is dependant on previously-sent/previously-received messages, thereby giving this testing framework the ability to construct SIP messages that are adapted to the run-time scenario. In other words, the construction of SIP messages in SIP-Director is adaptive in nature as well.

Checker:

As mentioned earlier, a Negotiator relies on Checkers to determine the correctness of messages received by the Negotiator. Therefore, a Checker will be used by a Negotiator when the Negotiator is executing an instruction whose action type is “RECEIVE”.

A Checker works in the following way: It is initialized with (1) the message file referenced in the current instruction and (2) the value of timeout duration specified in the current instruction. The checker, if needed, may start a timer with the timeout value at the beginning of the execution of the current instruction. Every time a message is received by the Negotiator, the message is passed to the Checker for it to decide whether or not the message received is correct. In response, the Checker may (1) issue a positive decision to indicate that the message was correct, or (2) issue a negative decision to indicate that the message was incorrect or inopportune, or (3) wait silently for the next message to arrive or the timeout duration to pass and issue a decision at a later time. At some point, the Checker is bound to issue a decision.

The users of SIP-Director can choose to design and use their own Checkers. The following particular implementations of the Checkers are provided for example, not as limitation.

When Checkers in the “Standard” series is initialized by the message file, they will use the StandardRewriter to rewrite the content of the file. The rewritten content will become the set of criteria that the Checker uses to check for the validity of the message received by the Negotiator. As soon as a message is received by the Negotiator, it will be passed to the Checker which will perform the check. Both the result of the check and the timing of the arrival of the message will contribute to the final decision made by the Checker.

A particular embodiment of the Checkers are described in the following.

“Blind” Series:

(a) BlindChecker It will issue a positive decision as soon as a message is received by the Negotiator. The content of the message does not matter. It will issue a negative decision only when it times out.

(b) AutisticBlindChecker It is an introvert and does not want to be disturbed. Therefore, it will issue a negative decision as soon as a message is received by the Negotiator. The content of the message does not matter. It will issue a positive decision only when it times out.

“Standard” Series:

(a) StandardChecker As soon as the first message is received by the Negotiator, it checks for its validity according to the criteria given in the message file. If it fulfills all the criteria, it will issue a positive decision; otherwise, it will issue a negative decision. It will also issue a negative decision when it times out.

(b) PatientStandardChecker It is very similar to “StandardChecker”. But, it will not easily give up on waiting for the expected message. It will issue a positive decision as soon as a received message fulfills all the criteria. It will issue a negative decision only when it times out.

(c) AutisticStandardChecker It is a “picky” introvert. It will issue a negative decision as soon as a message which fulfills all the criteria is received by the Negotiator. It will issue a positive decision when it times out or when a message which does not fulfill all the criteria is received by the Negotiator.

(d) AutisticPatientStandardChecker It is very similar to AutisticStandardChecker. The only difference is that it is more patient. It will issue a positive decision when it times out. It will ignore all received messages that do not fulfill all the criteria and wait patiently. It will issue a negative decision when a message that fulfils all the criteria arrives.

Checkers in the “Standard” series are all based on the StandardChecker.

All Checkers in the “Standard” series work the same way as the StandardChecker in determining whether or not a received message is correct. Therefore, the discussion will be focused on how the StandardChecker determines the correctness of a received message.

According to RFC 3261, a SIP message begins with a Request line or Response line, followed by some SIP headers, possibly followed by a message body. The message body is optional.

When checking an actual received message for its correctness (or validity), the following information in the message will be considered:

(a) Whether or not the Request line uses an expected request method.

(b) Whether or not the Response line uses an expected response code.

(c) Whether or not the message contains some headers of certain header names whose header values are unimportant.

(d) Whether or not the message contains some headers of certain header names whose header values are important.

(e) Other issues that may included for a specific situation.

Therefore, when the StandardChecker checks an actual received message for its validity, it should look for the same information. It is the message file that tells the StandardChecker what exactly to look for in the received SIP message. In other words, the message file forms the criteria used by the StandardChecker to check the received message.

Therefore, in one embodiment, the message file has to indicate to the StandardChecker what request method is expected in the received message, what response code is expected in the received message, what headers must be present, and what headers must not be present, etc. The message file should be formatted in such a way that these criteria can be easily expressed by the user and easily interpreted by the StandardChecker. It naturally follows that the presentation of the criteria will greatly resemble a regular SIP message.

When the StandardChecker is initialized, it will use the StandardRewriter to resolve all predefined tags into actual values as described in the above. After the rewriting process, the content of the message file will look very much like a SIP message with special prefixes appearing before some of the SIP headers.

In certain embodiments, the rewritten content of the message file will be interpreted by the StandardChecker in the following way:

(a) The first line tells the StandardChecker what request method or response code is expected of the received messages.

(b) The remaining lines tell the StandardChecker what SIP headers must be present or what SIP headers must not be present. As defined in RFC 3261, a line is defined as a piece of text ended with CrLf. Predefined markers are used to indicate what is expected and what is not expected. The markers will be discussed in the following.

Markers that are recognized by Checkers in the “Standard” series: Each line in the message template represents an independent criterion that the received message has to fulfill. Except the first line, all other lines may be prefixed with “markers” to indicate the nature of expectation. The following explains each marker in detail:

(a) ˜EHV˜

This marker stands for Expected Header Value. It is the default marker when no marker is specified. It tells the Checker that the SIP header (the header name and the header value) that follows this marker must exist in the received message in order for the criterion to be fulfilled.

Example:

˜EHV˜Max-Forwards: 70

The above line represents the criterion that a “Max-Forwards” header with value “70” must be present in the received message.

(b) ˜EHN˜

This marker stands for Expected Header Name. It tells the Checker that a SIP header with the same name as what follows this marker must exist in the received message in order for the criterion to be satisfied.

Example:

˜EHN˜Call-ID: *

The above line represents the criterion that at least one “Call-ID” header must be present in the received message. The value of the header is unimportant.

(c) ˜UHV˜

This marker stands for Unwelcome Header Value. It tells the Checker that SIP header (the header name and the header value) that follows this marker must NOT exist in the received message in order for the criterion to be fulfilled.

Example:

˜UHV˜CSeq: 1 INVITE

The above line represents the criterion that a “Cseq” header with value “1 INVITE” must not be present in the received message.

(d) ˜UHN˜

This marker stands for Unwelcome Header Name. It tells the Checker that a SIP header with the same name as what follows this marker must NOT exist in the received message in order for the criterion to be fulfilled.

Example:

˜UHN˜Contact: *

The line above represents the criterion that no “Contact” header is allowed in the received message regardless of its value.

The various Checkers provided in the current implementation allow users of the testing frame work to conceive suitable sophisticated test cases to test their SUT. Users can even design their own Checker to check for the correctness of the received messages, thereby allowing this testing methodology to extend to testing other communication protocols.

Different types of markers cover most, if not all, imaginable scenarios in checking for the validity of SIP headers. The achievement of expressing complex criteria without requiring the user to write complicated scripts is a feature of embodiments of the present invention.

Structure of Test Cases and Automatic Generation of Documentation

Hierarchical Test Case Organization:

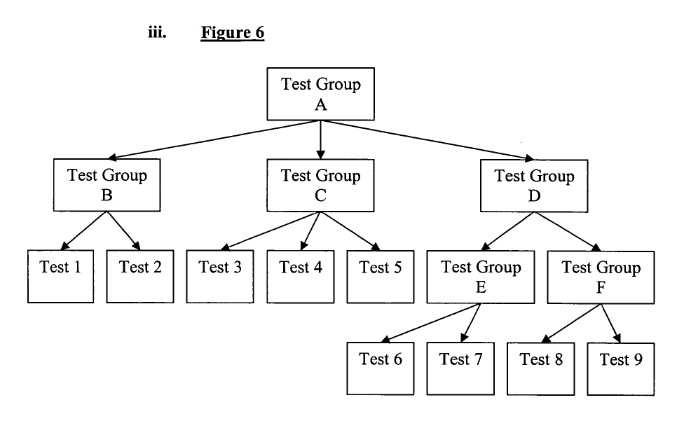

A test case is a specification of a message flow which should take place among Negotiators and the system under test, and is specified in the form of a screenplay file and associated message files. In accordance with one particular embodiment of the present invention, the test cases are organized logically in a hierarchical fashion, whereby a test case can be part of a test group, which in turn can be part of a larger group, and so on. There is no limit to the number of levels of grouping to which the test cases in a particular embodiment can be organized. FIG. 6 shows one example of such a hierarchy of test cases.

The grouping of test cases can be based on any criteria which the user deems suitable. For example, test cases can be grouped based on their similarity, commonality of message flows, logical section in the RFC to which the behavior exemplified by the test case belongs, and so on.

As a particular embodiment, the physical organization (on a file system, for example) of screenplay files and associated message files may follow the same hierarchy as the logical organization of the associated test cases. This allows easy maintenance of the files.

The tests can be performed individually or can be batch-executed automatically using a script or other suitable mechanisms. However, a more powerful and logical fashion in which the user can perform tests is to base it on the hierarchical organization of the test cases described above. Thus, he or she can request the execution of a group of tests by specifying an identifier which identifies a particular group in the hierarchy of test cases. This is more powerful because the user can easily request the execution of an arbitrarily large group of tests by simply specifying an identifier. This is also more logical because it aligns the organization of test cases with their execution.

Automated Documentation Generation:

In creating a test case, providing the associated documentation about the test case is as important as specifying the message flow. Such documentation could include descriptions of the intent of the test, the relevant portions in the related RFC which are associated with the test, the key characteristics in the message flow or concept of the test, a graphical representation of the message flow, and so on. The documentation is instrumental in the planning and management of the testing process, and could be critical as the number of test cases grow beyond a handful.

The specification of a test case includes the writing of a documentation source file. The documentation source file has a well-defined format and placeholders for key pieces of information about the test case such as name of the test, description of the test, precondition of the test, references such as RFC references, message flow, and so on.

The test case documentation source files may follow the same hierarchical organization as the actual test cases. They reside in the same physical location in the hierarchy (on a file system, for example) as the screenplay files and message files. This allows easy maintenance of the documentation source files along with their screenplay files and message files.

In a particular embodiment, there is a facility which generates documentation in HTML format from the documentation source files. Such facility can be implemented by people with ordinary skill in the art. HTML documentation generated includes complete hyperlinks which allow easy navigation through the hierarchy of test cases. The user of the test framework may issue a simple command whenever the documentation needs to be generated, and the documentation for the whole hierarchy of test cases can be generated automatically.

Furthermore, the test case documentation source files contain tags to be replaced with certain pieces of information which are derived from the screenplay files and message files, such as the message flow. The provision of such tags eliminates repetitive entry of information which is found in the screenplay files and message files.

While there have been described and pointed out fundamental novel features of the invention as applied to a preferred embodiment thereof, it will be understood that various omissions and substitutions and changes, in the form and details of the testing framework and methods illustrated, may be made by those skilled in the art without departing from the spirit of the invention. For example, it is expressly intended that all combinations of those elements of the framework and/or method acts which perform substantially the same function in substantially the same way to achieve the same results are within the scope of the invention.

The invention is not limited by the embodiments described above which are presented as examples only but can be modified in various ways within the scope of protection defined by the appended patent claims.

In interpreting the appended patent claims, the definitions provided in the following should take precedent if they are inconsistent with descriptions elsewhere in the specification.

“TestComputer” is any computing device which can execute a software program and has a network interface. A typical such device includes, among other elements, a central computer unit (CPU), random access memory (RAM), an operating system (OS) and a network card.

“TestDirector” is any computer software program which is solely for testing or diagnosing purposes and which can interact with other testing or diagnosing computer software programs running in the same TestComputer or in one or more different TestComputers.

“SUT” means the system under test.

“Negotiator” is any computer software program which is solely for testing or diagnosing purposes, which can interact with other testing or diagnosing computer software programs running in the same TestComputer or in one or more different TestComputers and which, through connection to a network, can communicate with devices within the network.

“Checker” is a software unit for determining whether an error has occurred by comparing the content of a message actually received in network communication and the content expected.

“Rewriter” is a software unit for converting a computer-readable file (a digital data stream) into a message according to a set of predetermined rules so that the resulting message is in a format complying with a network communication protocol.

“Test case,” “screenplay file,” and “message file” are computer-readable files or digital data streams, the context of which may be rendered human-readable by a computer on a computer screen or a hardcopy printout. A “test case” is a deterministic flow of testing messages between the SUT and one of more Negotiators. A “screenplay file” specifies the message flow, much like a script used in shooting movies.

“Static and run-time information” means information about a test case and the testing results obtained following its execution, which for example may include the name of the test, description of the test, precondition of the test, RFC references, message flow, indication of any communication errors and the reasons thereof, or any other information a user believes is useful and suitable for documentation. Of course, one or more pieces of the above specified information can be omitted.

What is claimed is:

1. A system for testing compliance and robustness of a communication protocol of an entity which is connected to an IP based network, comprising:
(a) one or more TestComputers;
(b) one or more Negotiators; and
(c) a TestDirector; where said one or more Negotiators and said TestDirector are software programs and are installed in said one or more TestComputers; said one or more Negotiators have connectivity to said IP based network, thereby communicating with said entity using said communication protocol; said TestDirector has connectivity to said one or more Negotiators, thereby sending a command to said one or more Negotiators to perform a job, said job is either sending a message in a format complying with said communication protocol to said entity or waiting to receive another message in a format complying with said communication protocol from said entity.

2. The system of claim 1, further comprising one or more files stored in a computer readable-medium and accessible by said TestDirector.

3. The system of claim 2, wherein said one or more files are also accessible by said one or more Negotiators.

4. The system of claim 3, wherein said one or more files comprise a test case having an ID, a screenplay file and one or more message files, said screenplay file containing at least one instruction and being referenced in said test case; wherein said command sent by said TestDirector to said one or more Negotiators includes said ID of said test case and said job is specified by said instruction in said screenplay file referenced in said test case.

5. The system of claim 2, wherein said Negotiator comprises a first component which functions as a Checker, said Checker being capable of comparing the content of said another message received in performing said job and the content of one of said files for making a determination whether a communication error has occurred.

6. The system of claim 5, wherein said Negotiator sends a report to said TestDirector based on said determination made by said Checker, said report being optionally displayed by said TestDirector on a screen or a printout.

7. The system of claim 5, wherein said Negotiator further comprises a second component which functions a Rewriter, said Rewriter capable of transforming the content of one of said files into said message to be used in performing said job.

8. The system of claim 1, wherein said TestDirector is installed in a TestComputer where none of said Negotiators is installed.

9. The system of claim 1, wherein said TestDirector is installed in a TestComputer where one or more of said Negotiators is installed.

10. The system of claim 1, wherein each of said TestDirector and said one or more Negotiators is installed in a separate TestComputer.

11. The system of claim 2, wherein said one or more files are stored in a computer-readable medium within a TestComputer where said TestDirector or one of said Negotiators is installed, or said one or more files are stored in a computer-readable medium within a device or a TestComputer where neither said TestDirector nor said one or more of Negotiators is installed.

12. A method of testing compliance and robustness of a communication protocol of an entity under test which is connected to a network, comprising:
(a) preparing a test case, a screenplay file and a set of message files according to predetermined rules;
(b) executing a TestDirector with said test case as an input;
(c) executing one or more Negotiators which is in communication with said TestDirector;
(d) sending a command by said TestDirector to said Negotiators;
(e) sending a message by said Negotiators based on said command received from said TestDirector, said message being sent to said entity under test in a network to which said Negotiators are connected;
(f) awaiting another message being sent to said Negotiators until a specified timeout lapses, said another message if arrived within said specified timeout being subject to an examination by said Negotiators to determine whether a communication error has occurred; and
(g) sending a report by said Negotiators to said TestDirector based on said examination.

13. The method of claim 12, further comprising (h): displaying on screen or printing out on paper of said report by said TestDirector.

14. The method of claim 12, further comprising (i): wherein (a) further comprises preparing a test case documentation source file in a predetermined format containing placeholders and (i) is performed during or between (a)-(g) by gathering static and run-time information during said testing (a)-(g) and replacing said placeholders with said static and run-time information.

15. The method of claim 12, wherein said TestDirector has no direct connectivity to said entity under test.

16. The method of claim 12, wherein in (e) said message is converted from one of said message files prepared in (a) so that said message is a format in compliance with said communication protocol.

17. The method of claim 12, wherein in (f) said examination by said Negotiator to determine whether a communication error has occurred is accomplished by comparing the content of said another message with the content of one of said message files prepared in (a).

18. The method of claim 12, wherein each of said Negotiators and said TestDirector is running in a separate TestComputer.

19. The method of claim 12, wherein said TestDirector and one or more of said Negotiators are running in one TestComputer.

20. The method of claim 12, wherein said communication protocol is SIP.
